(19) United States
(12) Patent Application Publication
(10) Pub. No.: US 2016/0241773 A1
(43) Pub. Date: Aug. 18, 2016

(54) LENS MODULE SYSTEM, IMAGE SENSOR, AND METHOD OF CONTROLLING LENS MODULE

(71) Applicant: RENESAS ELECTRONICS CORPORATION, Tokyo (JP)

(72) Inventors: Koji SHIDA, Tokyo (JP); Shinya TANAKA, Tokyo (JP)

(21) Appl. No.: 14/965,353

(22) Filed: Dec. 10, 2015

(30) Foreign Application Priority Data
Feb. 18, 2015 (JP) 2015-029449

(51) Int. Cl. H04N 5/232; H04N 5/357; H04N 5/238; G06K 9/46; G02B 15/14; G02B 7/09

(52) U.S. Cl. CPC H04N 5/23212; G02B 15/14; G02B 7/09; H04N 5/23296; H04N 5/238; G06K 9/4642; G06K 9/4661; H04N 5/23229; H04N 5/357

(57) ABSTRACT

In an existing camera, a control program of a whole camera including a control program for controlling a lens group and a sensor needs to be entirely created by a camera manufacturer, which increases the number of man-hours of product development. According to one embodiment, in a lens module system, a lens module includes a lens group, an image sensor and a module control unit. Image feature information representing a feature of image information taken is output from the image sensor, and the module control unit controls a component of the lens group based on the image feature information.

### CROSS-REFERENCE TO RELATED APPLICATIONS

This application is based upon and claims the benefit of priority from Japanese patent application No. 2015-029449, filed on Feb. 18, 2015, the disclosure of which is incorporated herein in its entirety by reference.

### BACKGROUND

The present invention relates to a lens module system and a method of controlling a lens module and, for example, relates to a lens module system and a method of controlling a lens module with autofocus feature.

There is an increasing need for video cameras such as a surveillance camera. In such cameras, it is necessary to continue to focus on a subject. Particularly, in video cameras, it is necessary that the position of a lens continues to follow a moving subject. For the following control of a lens, it is necessary to make fine adjustments to control software for each lens type. It is therefore necessary to develop control software each time introducing an image sensor (sensor) and a lens. One example of a camera system is disclosed in Japanese Unexamined Patent Application Publication No. 2014-32234.

The imaging device disclosed in Japanese Unexamined Patent Application Publication No. 2014-32234 includes an imaging optical system, a focus control means for moving at least some of lenses in the imaging optical system based on the contrast of images formed by the imaging optical system, and a moving distance correction means for correcting the moving distance of at least some of lenses output from the focus control means according to mounting of a converter optical system on the imaging optical system. This imaging device further includes a camera/AF microcomputer (microcomputer) that includes a moving distance correction means. This imaging device controls the whole camera system including autofocus by the microcomputer.

### SUMMARY

However, control software including control software for a lens and a sensor needs to be designed according to the characteristics of the sensor or the lens, which requires many man-hours. As the number of products to be developed increases, the large number of man-hours required for development of control software creates a more serious bottleneck. The other problems and novel features of the present invention will become apparent from the description of the specification and the accompanying drawings.

In a lens module system, an image sensor, and a method of controlling a lens module according to one embodiment, the lens module includes a lens group, an image sensor, and a module control unit, and image feature information representing a feature of image information taken is output from the image sensor, and the module control unit controls a component of the lens group based on the image feature information.

According to one embodiment, it is possible to provide a lens module with a control program related to control of lenses and a sensor included therein.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram of a camera system including a lens module according to a first embodiment.

FIG. 2 is a block diagram of an image sensor according to the first embodiment.

FIG. 3 is a view illustrating connections between a module control MCU and a system control MCU according to the first embodiment.

FIG. 4 is a sequence chart illustrating an operation from startup to termination of a camera system according to the first embodiment.

FIG. 5 is a graph illustrating resolution information in the lens module according to the first embodiment.

FIG. 6 is a graph illustrating a gain curve in the lens module according to the first embodiment.

FIG. 7 is a sequence chart illustrating operations during normal operation of the camera system according to the first embodiment.

FIG. 8 is a block diagram of a camera system including a lens module according to a second embodiment.

FIG. 9 is a block diagram of an image sensor according to the second embodiment.

FIG. 10 is a view illustrating a signal flow until image information is output from incident light in the lens module according to the second embodiment.

FIG. 11 is a view illustrating lines set in an imaging region in the image sensor according to the second embodiment.

FIG. 12 is a timing chart illustrating an operation of the lens module according to the second embodiment.

FIG. 13 is a block diagram of a camera system including a lens module according to a third embodiment.

FIG. 14 is a flowchart comparing an operation of the camera system according to the third embodiment with an operation of a camera system according to a comparative example.

FIG. 15 is a timing chart comparing an operation of the camera system according to the third embodiment with an operation of a camera system according to a comparative example.

FIG. 16 is a block diagram of a camera system including a lens module according to a fourth embodiment.

FIG. 17 is a block diagram of an image sensor according to the fourth embodiment.

FIG. 18 is a flowchart of a method for acquiring pixel defect information in the lens module according to the fourth embodiment.

FIG. 19 is a flowchart for reflecting pixel defect information on the system in the lens module according to the fourth embodiment.

### DETAILED DESCRIPTION

### First Embodiment

Exemplary embodiments of the present invention will be explained hereinbelow with reference to the drawings. The following description and the attached drawings are appropriately shortened and simplified to clarify the explanation. Further, elements that are shown as functional blocks for performing various kinds of processing in the drawings may be configured by a CPU, memory or another circuit as hardware or may be implemented by a program loaded to memory or the like as software. It would be thus obvious to those skilled in the art that those functional blocks may be implemented in various forms such as hardware only, software only or a combination of those, and not limited to either one. Note that, in the drawings, the same elements are denoted by the same reference symbols and redundant description thereof is omitted as appropriate.

Further, the above-described program can be stored and provided to the computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or optical fiber or a wireless communication line.

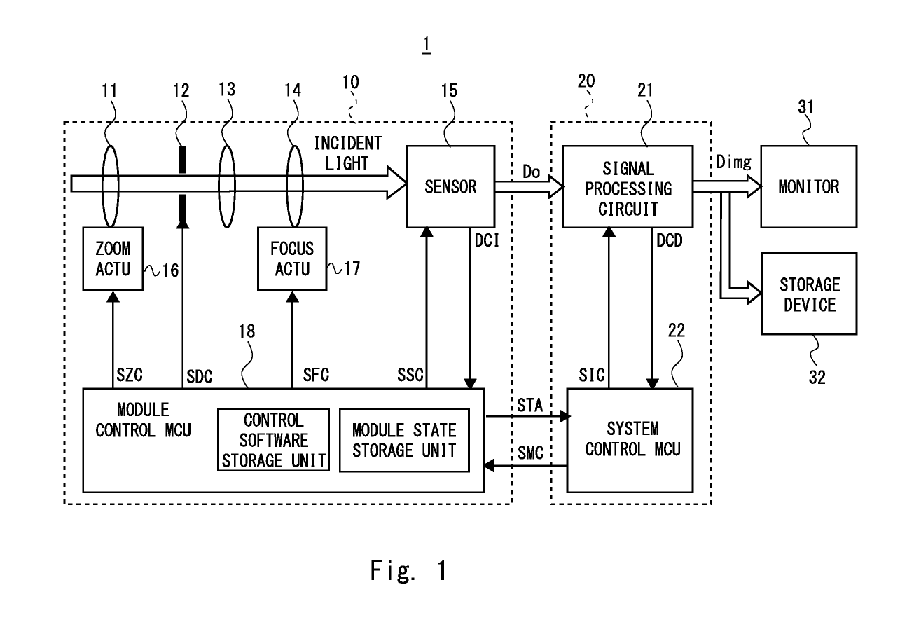

FIG. 1 is a block diagram of a camera system 1 according to a first embodiment. The camera system 1 shown in FIG. 1 includes a lens module 10 according to the first embodiment. As shown in FIG. 1, the camera system 1 according to the first embodiment includes the lens module 10 and a camera body 20. Further, the camera system 1 according to the first embodiment includes at least one of a monitor 31 and a storage device 32.

In the camera system 1 according to the first embodiment, image information Do is generated by the lens module 10, and the image information Do may be moving images. In the camera system 1 according to the first embodiment, the image information Do taken by the lens module 10 is acquired by a camera body 20, and the camera body 20 performs image processing on the image information Do and thereby outputs image data Dimg. Then, in the camera system 1 according to the first embodiment, the image data Dimg is shown on a monitor 31 and stored in a storage device 32. One feature of the camera system 1 according to the first embodiment is that the lens module 10 performs specific processing of autofocus processing and auto exposure control, and the camera body 20 does not perform specific processing of autofocus processing and auto exposure control. Thus, in the camera system 1 according to the first embodiment, a control program related to autofocus processing and auto exposure control is not included in the camera body 20. Note that, in the camera system 1 according to the first embodiment, any one of autofocus processing and auto exposure control may be performed as processing in the lens module 10. The specific configuration and operation of the camera system 1 according to the first embodiment are described hereinafter in detail.

The lens module 10 includes a lens group, an image sensor (for example, a sensor 15) and a module control unit (for example, a module control MCU 18). The lens group includes a zoom lens 11, a diaphragm mechanism 12, a fixed lens 13 and a focus lens 14. The lens module 10 further includes a zoom lens actuator 16 for driving the zoom lens 11 and a focus lens actuator 17 for driving the focus lens 14. The lens group changes the focus by moving the lenses using the respective actuators and changes the amount of incident light by the operation of the diaphragm mechanism 12.

The zoom actuator 16 moves the zoom lens 11 and thereby changes the zoom magnification. The zoom actuator 16 moves the zoom lens 11 based on a zoom control signal SZC that is output from the module control MCU 18. The focus actuator 17 moves the focus lens 14 and thereby changes the focus of an image taken by the sensor 15. The focus actuator 17 moves the focus lens 14 based on a focus control signal SFC that is output from the module control MCU 18. The diaphragm mechanism 12 adjusts the amount of incident light that reaches the sensor 15 through the lens group. The diaphragm mechanism 12 adjusts the f-number by a diaphragm control signal SDC that is output from the module control MCU 18.

The sensor 15 includes a photoreceptor such as a photodiode, for example, and converts photoreceptor pixel information that is obtained from the photoreceptor into a digital value and outputs image information Do. Further, the sensor 15 analyzes the image information Do that is output from the sensor 15 and outputs image feature information DCI representing the feature of the image information Do. The image feature information DCI contains resolution information and luminance distribution information (for example, histogram data) of the image information Do. Note that the resolution information is information indicating the sharpness of the edge of the image information Do. Further, the sensor 15 performs gain control of each pixel of the image information Do, exposure control of the image information Do, and HDR (High Dynamic Range) control of the image information Do based on a sensor control signal SSC that is supplied from the module control MCU 18. The sensor 15 is described in detail later.

The module control MCU 18 controls at least one of the focus of the lens group and the exposure setting (for example, light exposure setting and gain setting) of the sensor 15 based on the image feature information DCI that is output from the sensor 15. To be specific, the module control MCU 18 outputs a focus control signal SFC to the focus actuator 17 and thereby controls the focus of the lens group. The module control MCU 18 outputs a diaphragm control signal SDC to the diaphragm mechanism 12 and thereby adjusts the f-number of the diaphragm mechanism 12. Further, the module control MCU 18 outputs a zoom control signal SZC to the zoom actuator 16 and thereby controls the zoom magnification of the lens group.

The module control MCU 18 changes the zoom magnification of the lens group and controls the focus at the changed magnification based on a zoom setting value indicating the zoom magnification from a system control unit (for example, a system control MCU 22) that is placed separately from the module control MCU 18 and controls the whole camera system based on an instruction from a user. Further, the module control MCU 18 controls the light exposure setting and the gain setting in the sensor 15 based on an exposure control value that is supplied from the system control MCU 22. Furthermore, when performing exposure control, the module control MCU 18 may adjust the amount of light that enters the sensor 15 through the lens group by controlling the diaphragm mechanism 12. The module control MCU 18 includes a control software storage unit that stores a control program for controlling the zoom, focus and exposure. The module control MCU 18 controls the zoom, focus and exposure based on the control software stored in the control software storage unit.

To be more specific, the module control MCU 18 receives the zoom setting value from the system control MCU 22 and then calculates a zoom lens control value for the zoom actuator 16 to determine the position of the zoom lens 11 after movement. At this time, because the zoom magnification is changed, the lens module 10 needs to change the focus. Thus, the module control MCU 18 controls the focus actuator 17 based on the resolution information contained in the image feature information DCI obtained from the sensor 15, and the sensor 15 appropriately controls the focus of the image information Do to be output. The processing that automatically adjusts the focus in this manner is autofocus control. In this autofocus control, the module control MCU 18 searches for the lens position at which the resolution information reaches its maximum by moving the lens included in the lens group and sets the lens position at which the resolution information reaches its maximum as the position where the focus is achieved.

Further, when an exposure control value that instructs the exposure setting is received from the system control MCU 22, the module control MCU 18 controls the light exposure setting and the gain setting of the sensor 15 so that the histogram data contained in the image feature information DCI that is output from the sensor 15 matches the exposure control value. At this time, the module control MCU 18 calculates a control value for changing the light exposure setting and the gain setting of the sensor 15 from a difference between the exposure control value received from the system control MCU 22 and the histogram data. Further, when changing the exposure, the module control MCU 18 may calculate a control value of the diaphragm mechanism 12 as well.

Further, the module control MCU 18 initializes the lens module system based on a power-on reset instruction that is supplied from the system control MCU 22, and terminates the lens module system based on a power-off instruction that is supplied from the system control MCU 22.

The module control MCU 18 includes a module state storage unit and the control software storage unit. The module control MCU 18 stores a state value indicating the operation status such as the lens position of the lens module 10 and the operating state into the module state storage unit, and outputs the stored state value to the system control MCU 22 in response to a request from the system control MCU 22. The module control MCU 18 stores control software for controlling the lens module 10 into the control software storage unit. This control software is to calculate a control value when controlling the lens group or the sensor 15 based on an instruction supplied from the system control MCU 22 and to perform specific control processing based on the calculated control value.

The camera body 20 is described hereinafter. As shown in FIG. 1, the camera body 20 includes a signal processing circuit 21 and a system control unit (for example, the system control MCU 22).

The signal processing circuit 21 performs image processing such as image correction on the image information Do that is received from the lens module 10 and outputs image data Dimg. The signal processing circuit 21 analyzes the received image information Do and outputs color space information DCD. The color space information DCD contains luminance information and color information of the image information Do, for example.

The system control MCU 22 controls the camera system as a whole based on an instruction from a user. For example, the system control MCU 22 outputs the zoom setting value instructing a change of the zoom magnification to the module control MCU 18 based on an instruction from a user. Further, the system control MCU 22 outputs a color space control signal SIC for adjusting the luminance or color of the image data Dimg based on an instruction from a user. Note that the system control MCU 22 generates the color space control signal SIC based on a difference between the color space information DCD that is acquired from the signal processing circuit 21 and information that is supplied from the user.

Further, the system control MCU 22 controls the operation of the whole camera system such as the startup and termination processing of the camera system 1, a change of the type of an image to be acquired, and a change of the zoom magnification. Note that, however, in the camera system 1 according to the first embodiment, the system control MCU 22 only instructs the change of the zoom magnification and the exposure control to the lens module 10 and does not perform specific processing such as autofocus processing or auto exposure control.

Furthermore, the system control MCU 22 transmits various instructions by outputting a module control signal SMC to the module control MCU 18 and receives a response to the output instruction as a module state response STA.

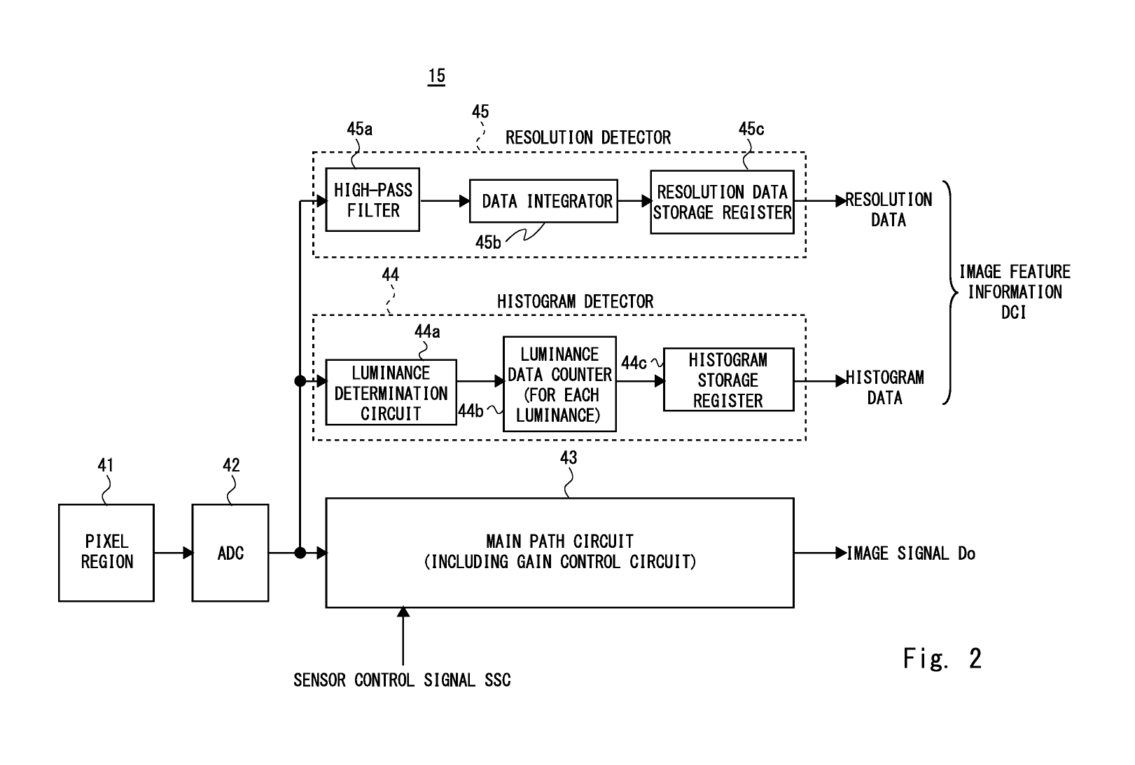

A specific configuration of the sensor 15 is described hereinafter in detail. FIG. 2 shows a block diagram of the sensor 15 according to the first embodiment. As shown in FIG. 2, the sensor 15 according to the first embodiment includes a pixel region 41, an analog-to-digital converter 42, a main path circuit 43, a histogram generation unit (for example, a histogram detector 44), a resolution information generation unit (for example, a resolution detector 45).

The pixel region 41 is a sensor unit that outputs photoreceptor pixel information generated according to the amount of light entering through the lens group whose focus and exposure are variable. In this pixel region 41, photodiodes are arranged in a lattice. Further, the pixel region 41 includes a reading circuit that reads the photoreceptor pixel information for each row of the photodiodes arranged in a lattice. The analog-to-digital converter 42 converts the photoreceptor pixel information into a digital value and thereby generates image information.

The main path circuit 43 is a circuit that outputs image information to the outside. The main path circuit 43 includes a plurality of circuits such as a gain control circuit and a latch circuit. The gain control circuit included in the main path circuit 43 performs gain control that changes the luminance resolution for each pixel according to the luminance of pixels in the image information based on an instruction from the outside. The latch circuit temporarily stores the image information to make the output timing of the image information coincide with the clock timing.

In the sensor 15, the histogram detector 44 and the resolution detector 45 constitute an image analysis unit. The image analysis unit analyzes the image information that is output from the analog-to-digital converter 42 and outputs image feature information representing the feature of the image information.

The histogram detector 44 generates histogram data of the image information. The histogram detector 44 includes a luminance determination circuit 44a, a luminance data counter 44b, and a histogram storage register 44c. The luminance determination circuit 44a determines the luminance of each of the pixels contained in the image information. The luminance data counter 44b counts the pixels whose luminance is determined by the luminance determination circuit 44a on a luminance-by-luminance basis and generates histogram data. The histogram storage register 44c stores the histogram data.

The resolution detector 45 generates resolution information indicating the sharpness of the edge of the image information. The resolution detector 45 includes a high-pass filter 45a, a data integrator 45b, and a resolution data storage register 45c. The high-pass filter 45a extracts only the pixels of a part that serves as the edge in the image information. The data integrator 45b integrates the number of pixels extracted by the high-pass filter. The resolution data storage register 45c stores the number of pixels integrated by the data integrator 45b.

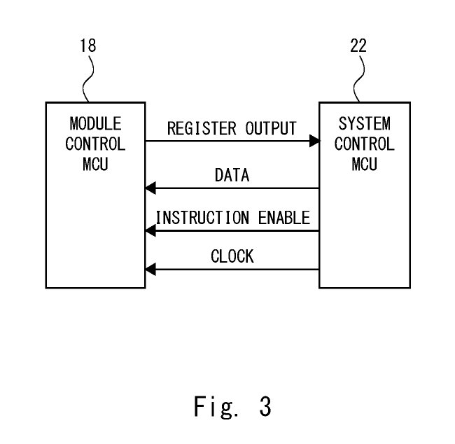

The operation of the camera system 1 according to the first embodiment is described hereinafter. Prior to describing the operation of the camera system 1, the way of transmitting and receiving instructions and data between the system control MCU 22 and the module control MCU 18 is described first. FIG. 3 shows a view illustrating connections between the module control MCU and the system control MCU according to the first embodiment.

As shown in FIG. 3, the system control MCU 22 and the module control MCU 18 transmit and receive instructions and data by serial signals. To be specific, the system control MCU 22 transmits data and a clock as a synchronization signal to the module control MCU 18. This data serves as an instruction. Further, the system control MCU 22 outputs an instruction enable signal. When the instruction enable signal indicates the enabled state (for example, high level), the module control MCU 18 receives the instruction. Further, when the instruction received from the system control MCU 22 requires a response, the module control MCU 18 outputs the state value stored in the module state storage unit included therein as a register output to the system control MCU 22. Note that, although the case of using three signals, clock, data and enable, as serial signals is described in the above example, this is the same for the communication using two-channel signals such as I²C bus.

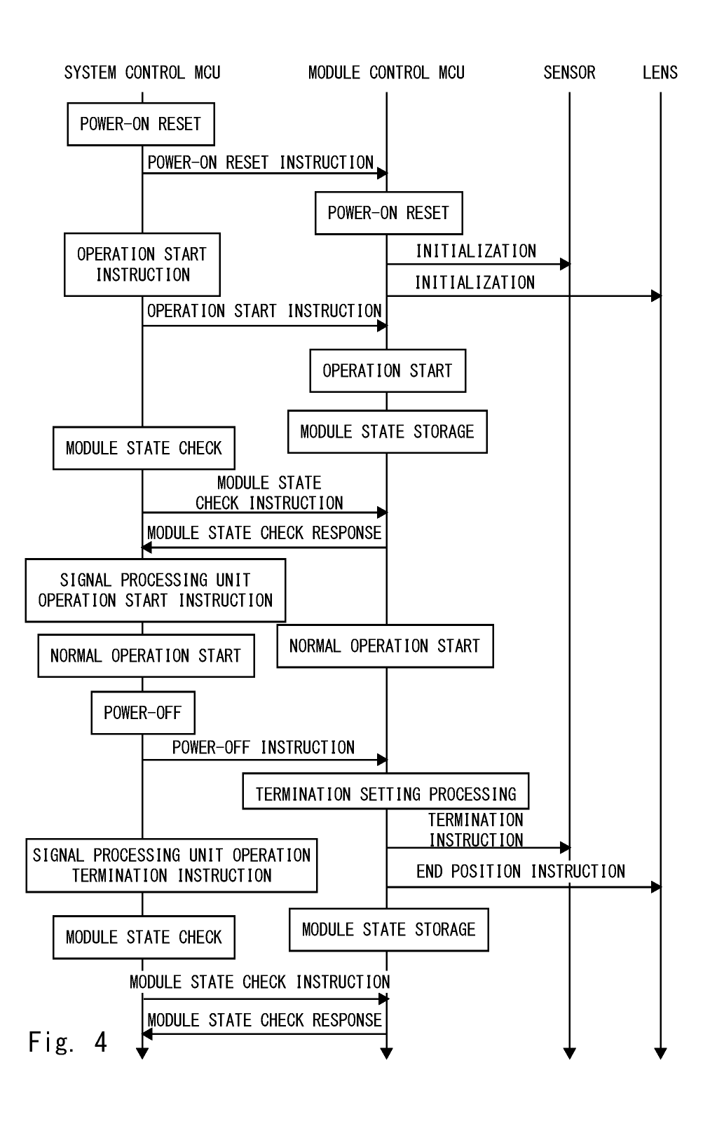

A specific operation of the camera system 1 is described hereinafter. FIG. 4 shows a flowchart illustrating the operation from the startup to the termination of the camera system 1 according to the first embodiment. As shown in FIG. 4, upon the startup, the camera system 1 according to the first embodiment resets the system control MCU 22 (for example, power-on reset). In the power-on reset of the system control MCU 22, a power-on reset instruction is transmitted from the system control MCU 22 to the module control MCU 18. Then, the module control MCU 18 performs a reset operation (for example, power-on reset) in response to the received power-on reset instruction. In the power-on reset processing performed by the module control MCU 18, the initialization processing of the sensor 15 and the lens group is also done. In the initialization processing of the sensor 15, the initialization of operation timing and the initialization of each setting value are performed. Further, in the initialization processing of the lens group, the position of each lens is moved back to its initial position. At this time, the module control MCU 18 stores the current status into the module state storage unit one after another. Then, the system control MCU 22 reads the state of the module control MCU 18 at regular intervals. Note that, although control using polling is described as an example, interrupt control may be used instead.

Then, the system control MCU 22 recognizes that the initialization processing of the lens module 10 has completed based on the state value read from the module control MCU 18 and then outputs an operation start instruction to the module control MCU 18. The module control MCU 18 thereby starts the operation. Upon the start of the operation, the module control MCU 18 stores the module state into the module state storage unit.

Then, the system control MCU 22 performs module state check processing. In this module state check processing, the system control MCU 22 transmits a module state check instruction to the module control MCU 18. Then, the module control MCU 18 that has received the module state check instruction transmits the state value stored in the module state storage unit as a module state check response to the system control MCU 22.

After that, when it is found that the operation of the lens module 10 has started by the state value received from the module control MCU 18, the system control MCU 22 instructs the signal processing circuit 21 to start the operation of the signal processing unit. The camera body 20 thereby starts normal operation. On the other hand, upon transmitting the state of the module after the start of the operation as a state value to system control MCU 22, the module control MCU 18 starts normal operation. After starting normal operation, the lens module 10 starts outputting an image, and the signal processing circuit 21 starts processing the image information Do received from the lens module 10. Further, when the color information and luminance information contained in the color space information DCD output from the signal processing circuit 21 become desired ranges, the system control MCU 22 controls the signal processing circuit 21 to start outputting the image data Dimg to the outside. The details of the operation of the camera system 1 during normal operation are described later.

Then, the operation when terminating the camera system 1 according to the first embodiment is described hereinafter. When terminating the camera system 1, the system control MCU 22 starts the termination processing when power-off is instructed in response to an instruction from a user. In this termination processing, a power-off instruction is first transmitted from the system control MCU 22 to the module control MCU 18. After the system control MCU 22 transmits the power-off instruction to the module control MCU 18, it controls the signal processing circuit 21 to stop outputting the image data Dimg.

After that, the module control MCU 18 that has received the power-off instruction starts termination setting processing. In this termination setting processing, the module control MCU 18 outputs a termination instruction to the sensor 15. Further, in the termination setting processing, the end position is instructed to the lens group. Receiving the instruction about the end position, the lens group moves the lens to the position at which the widest-angle shooting is possible, for example. Upon completion of such termination setting processing, the lens module 10 sets the state value of the module stored in the module state storage unit to the stopped state. Then, the system control MCU 22 confirms that the state value read from the module control MCU 18 is in the stopped state and then permits the power-off to the outside.

The operations of the camera system 1 according to the first embodiment during normal operation are described hereinafter. The camera system 1 according to the first embodiment performs processing such as color signal processing, luminance signal processing, focus adjustment processing, zoom processing and HDR processing in normal operation.

In the color signal processing, the system control MCU 22 receives the color space information DCD from the signal processing circuit 21 on a regular basis. In the color space information DCD, color information and luminance information are contained. Then, the system control MCU 22 checks whether the color information and the luminance information are within desired ranges. At this time, when the color information deviated from the desired range, the system control MCU 22 outputs an instruction to rewrite the setting related to color to the signal processing circuit 21 and thereby makes adjustment so that the color balance of the signal processing circuit 21 becomes a desired color balance.

The luminance signal processing is processing in which the system control MCU 22 controls the signal processing circuit 21 and the lens module 10 based on the luminance information contained in the color space information DCD that is output from the signal processing circuit 21. The luminance of the image data Dimg is determined by an exposure time, a gain on the image information Do that is output from the sensor 15, and a digital gain that adjusts the brightness of a color and the contrast of a color in the signal processing circuit 21. Among those elements for determining the luminance, the adjustment of the digital gain is made by the signal processing circuit 21. On the other hand, the adjustment of the exposure time and the adjustment of the gain of the sensor 15 are made by the lens group and the sensor 15 in the lens module 10. Thus, the system control MCU 22 instructs the adjustment related to a digital gain to the signal processing circuit 21 and instructs the adjustment of an exposure time and the adjustment of a gain to the lens module 10 so that the range of the luminance information read from the signal processing circuit 21 becomes a desired range.

At this time, the system control MCU 22 instructs the adjustment of a digital gain to the signal processing circuit 21. On the other hand, the system control MCU 22 outputs only a luminance change instruction indicating a target value of brightness to the lens module 10. Then, the module control MCU 18 that has received the luminance change instruction from the system control MCU 22 calculates a control value so that the luminance information of the image information Do becomes a value instructed by the luminance instruction. At this time, the module control MCU 18 may calculate a control value that controls the diaphragm mechanism 12 and control the diaphragm mechanism 12 in the luminance signal processing.

Thus, in the camera system 1 according to the first embodiment, calculation of an exposure time and calculation of a gain in the sensor 15 can be performed in the lens module 10, instead of being performed in the system control MCU 22. Note that, in the case where all of the luminance signal processing is performed in the system control MCU 22, an exposure time setting value and a gain setting rewrite timing need to be differed, for example, for a change in setting to the signal processing circuit 21 and a change in setting to the lens group and the sensor 15. In the camera system 1 according to the first embodiment, because such a difference in the timing is adjusted in the lens module 10, it is possible to perform the luminance signal processing without consideration of a difference in the timing in the system control MCU 22.

The focus adjustment processing is processing in which the module control MCU 18 controls the focus actuator 17 based on the resolution information received from the sensor 15 and thereby moves the focus lens 14. The camera system 1 according to the first embodiment can perform the focus adjustment processing independently of the operations of the signal processing circuit 21 and the system control MCU 22. Further, the focus adjustment processing can be performed during the zoom processing which is described hereinbelow.

The zoom processing is processing that is performed when the system control MCU 22 receives a zoom change instruction from the outside. The zoom processing in the camera system 1 according to the first embodiment is processing in which the system control MCU 22 transmits the zoom change instruction from the outside to the module control MCU 18. In the camera system 1 according to the first embodiment, when the module control MCU 18 receives the zoom change instruction, the module control MCU 18 controls the zoom actuator 16 to move the position of the zoom lens 11 to the position at the zoom magnification indicated by the zoom change instruction. At this time, the focus is displaced with a change in the zoom magnification. Thus, in the camera system 1 according to the first embodiment, the focus that is displaced due to a change in the zoom magnification is adjusted by the module control MCU 18 controlling the focus actuator 17 based on the resolution information received from the sensor 15. Further, in the case of performing the zoom processing, a focal length changes, and therefore the module control MCU 18 may perform control of the diaphragm mechanism 12 as one of the zoom processing.

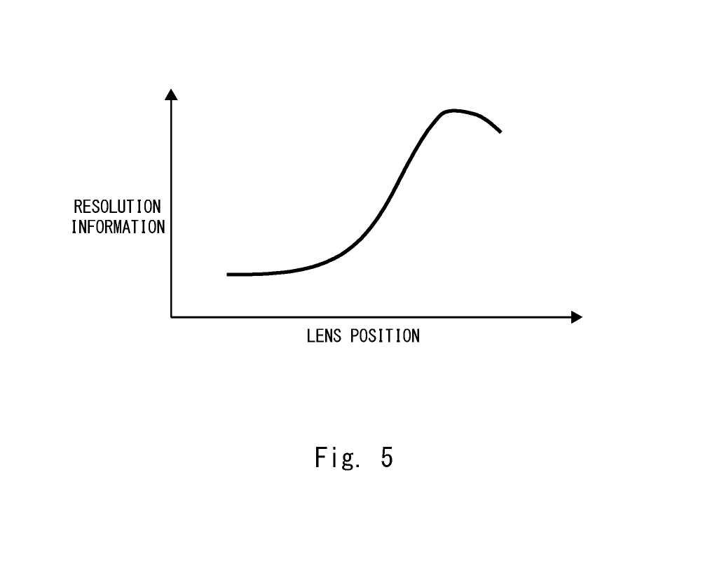

The focus processing is described in further detail hereinbelow. FIG. 5 shows a graph illustrating the resolution information in the lens module according to the first embodiment. As shown in FIG. 5, the resolution information increases or decreases depending on the lens position of the focus lens 14. This is because the sharpness of the edge of the image information Do acquired by the sensor 15 varies depending on the position of the focus lens 14. In the graph of FIG. 5, the lens position at which the resolution information reaches its maximum achieves the state where the focus of the image information Do is the most suitable. Thus, in the focus adjustment processing, the focus lens 14 is set at the position where the resolution information reaches the maximum based on the processing by the module control MCU 18.

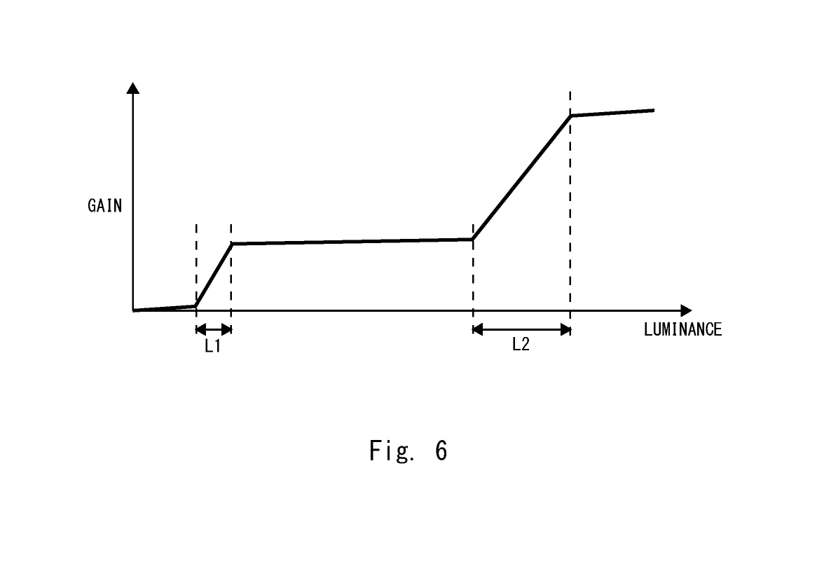

The HDR processing is described hereinafter. The HDR processing is processing in which the module control MCU 18 controls a gain curve of the sensor 15 based on the luminance distribution information (histogram data) that is received from the sensor 15. The gain curve is represented by the graph where the gain at each luminance is plotted. FIG. 6 shows a graph illustrating a gain curve in the lens module according to the first embodiment. As shown in FIG. 6, by adjusting the gain to be applied for each luminance of pixels acquired in the sensor 15, it is possible to output the image information Do with a wide luminance range by minimizing the degradation of the contrast of a subject. The example shown in FIG. 6 shows the case where there are many pixels in a luminance range L1 and a luminance range L2. In such a case, the image information Do with a wide dynamic range can be acquired by applying the gain to the luminance range L1 and the luminance range L2. In the camera system 1 according to the first embodiment, because the HDR processing is performed by the module control MCU 18, it is not necessary to prepare a control program related to the HDR processing in the signal processing circuit 21 and the system control MCU 22. Further, in the camera system 1 according to the first embodiment, the HDR processing is performed in the lens module 10 without receiving any instruction from the camera body 20.

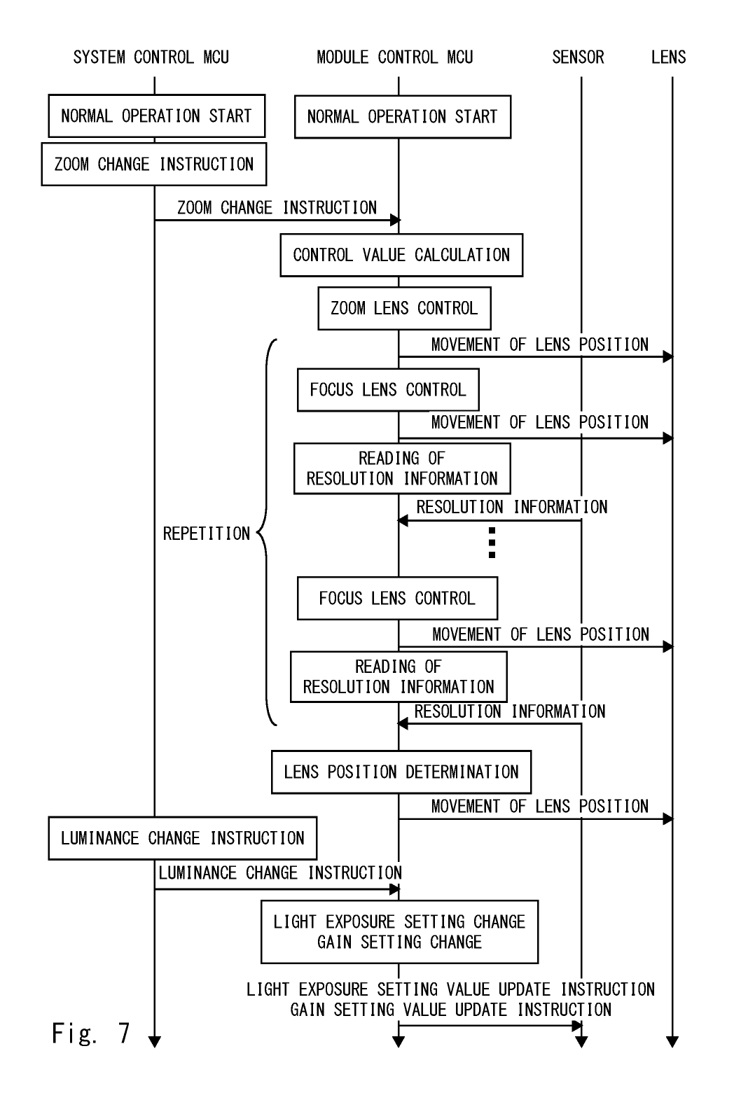

Out of the above-described normal operation, the focus adjustment processing including the focus adjustment processing during the zoom processing and the luminance signal processing are the exemplary characteristic processing in the camera system 1 according to the first embodiment. Thus, as the description of normal operation, the operations of the camera system 1 according to the first embodiment related to the focus adjustment processing and the luminance signal processing are described hereinbelow. FIG. 7 shows a sequence chart illustrating operations during normal operation of the camera system according to the first embodiment. FIG. 7 shows the operations related to the focus adjustment processing and the luminance signal processing which are extracted from normal operation of the camera system 1, and other operations are also performed in the camera system 1.

As shown in FIG. 7, in the camera system 1 according to the first embodiment, when a zoom change instruction is supplied to the system control MCU 22 during normal operation, the system control MCU 22 transmits the supplied zoom change instruction to the module control MCU 18. Receiving the zoom change instruction, the module control MCU 18 calculates a control value indicating a changed position of the zoom lens 11. Then, the module control MCU 18 changes the position of the zoom lens 11 by controlling the zoom actuator 16 according to the calculated control value.

When the position of the zoom lens 11 is changed, the focus is displaced, and therefore the module control MCU 18 moves the position of the focus lens 14 and reads the resolution information after the focus lens 14 is moved. Then, the module control MCU 18 repeats moving the focus lens 14 and reading the resolution information until obtaining the maximum value of the resolution information. After that, at the point of time when the maximum value of the resolution information is obtained, the module control MCU 18 performs the lens position determination processing that sets the position at which the maximum value of the resolution information is obtained as the position of the focus lens 14. The module control MCU 18 moves the focus lens 14 to the position determined by the lens position determination processing and thereby completes the zoom processing and the focus processing.

Further, as shown in FIG. 7, in the camera system 1 according to the first embodiment, a luminance change instruction is output from the system control MCU 22 to the module control MCU 18 when the luminance information output from the signal processing circuit 21 is deviated from a desired range. Receiving the luminance change instruction, the module control MCU 18 performs light exposure setting change that changes the light exposure setting of the sensor 15 based on a target value of the luminance contained in the luminance change instruction and gain setting change that changes the gain setting. In the exposure setting change, the exposure time after the change is calculated as a control value. Further, in the exposure setting change, the gain of the sensor 15 after the change is calculated as a control value. Then, the module control MCU 18 supplies the calculated control values as a sensor control signal to the sensor 15. Note that, although the exposure setting is changed in this example, only the diaphragm setting, or both of the exposure setting and the diaphragm setting may be changed.

As described above, in the camera system 1 according to the first embodiment, the module control MCU 18 controls the focus lens 14 based on the resolution information obtained from the sensor 15, thereby performing autofocus processing. Further, in the camera system 1 according to the first embodiment, the camera body 20 only supplies a zoom change instruction, and the module control MCU 18 calculates specific control values for controlling the zoom lens 11 and controls the zoom lens 11. Further, in the camera system 1 according to the first embodiment, the camera body 20 only supplies a luminance change instruction, and the module control MCU 18 changes the exposure setting and the gain setting of the sensor 15 and thereby changes the luminance of the image information Do. Further, in the camera system 1 according to the first embodiment, the module control MCU 18 performs the HDR processing by controlling the sensor 15. Accordingly, in the camera system 1 according to the first embodiment, the lens module 10 can independently perform control which requires calculation of control values in consideration of the characteristics of the lens group and the sensor 15. Therefore, in the camera system 1 according to the first embodiment, it is possible to acquire the image information Do with desired image quality from the lens module 10, without need for the camera body 20 to perform control which requires calculation of control values in consideration of the characteristics of the lens group and the sensor 15.

When designing a camera, it is necessary to design a control program related to autofocus control, auto exposure control, auto white balance control, HDR control and the like. Among those control, the autofocus control, the auto exposure control and the HDR control require the design in consideration of the characteristics of the lens group and the sensor 15. Therefore, in the camera design, it has been necessary to design a new control program for each lens or each sensor, which increases the number of design man-hours. Further, for the control of the lens and the sensor, particular know-how is required for each lens and each sensor, and therefore an increase in the number of man-hours for creation of the control program is a serious problem.

However, in the lens module 10 of the camera system 1 according to the first embodiment, the control program related to lens and sensor control is stored in the lens module 10 inside the module. Then, control in consideration of the characteristics of the lenses and the sensor is performed by the module control MCU 18 of the lens module 10 independently of the processing in the camera body 20. Therefore, in the camera system 1 according to the first embodiment, it is possible to obtain the desired image information Do from the lens module 10 only by instructing a desired result from the camera body 20 to the lens module 10.

By providing the above-described lens module 10 to a camera manufacturer, the camera manufacturer can design a camera without consideration of know-how about lenses and sensors. Further, with the above-described structure in which control related to lenses and sensors is done independently from the camera body 20, a lens manufacturer or a sensor manufacturer can create a control program related to lenses and sensors and provide the lens module 10 with the control program included therein to a camera manufacturer.

### Second Embodiment

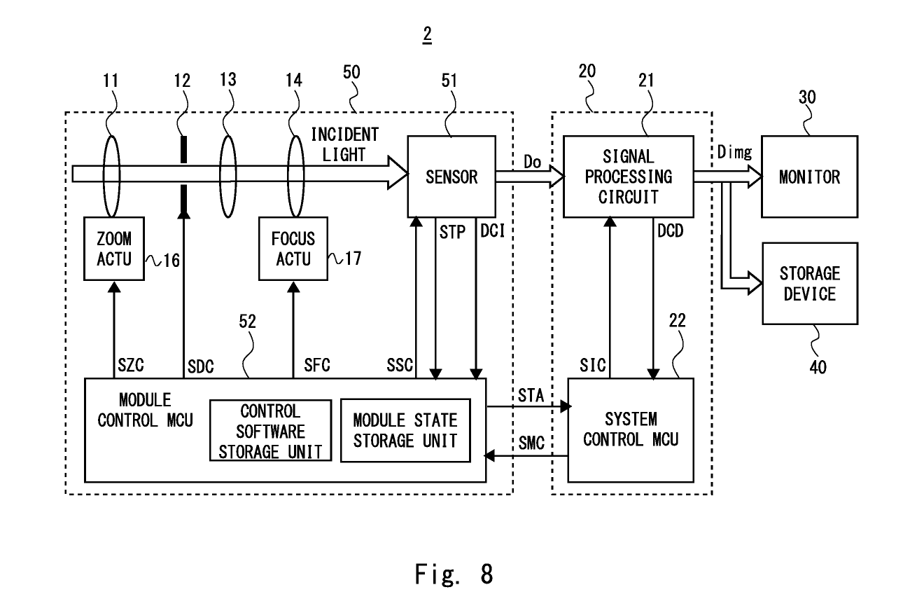

In a second embodiment, a lens module 50, which is an alternative example of the lens module 10, is described. FIG. 8 is a block diagram of a camera system 2 including the lens module 50 according to the second embodiment. Note that, in the description of the second embodiment, the elements described in the first embodiment are denoted by the same reference symbols as in the first embodiment and not redundantly described below.

As shown in FIG. 8, the lens module 50 includes a sensor 51 and a module control MCU 52 in place of the sensor 15 and the module control MCU 18. The sensor 51 further has a function of outputting a state display pulse STP in addition to the functions of the lens module 10. The module control MCU 52 further has a function of disabling the operation of the zoom actuator 16 and the focus actuator 17 based on the state display pulse STP. The sensor 51 and the module control MCU 52 are descried in further detail below.

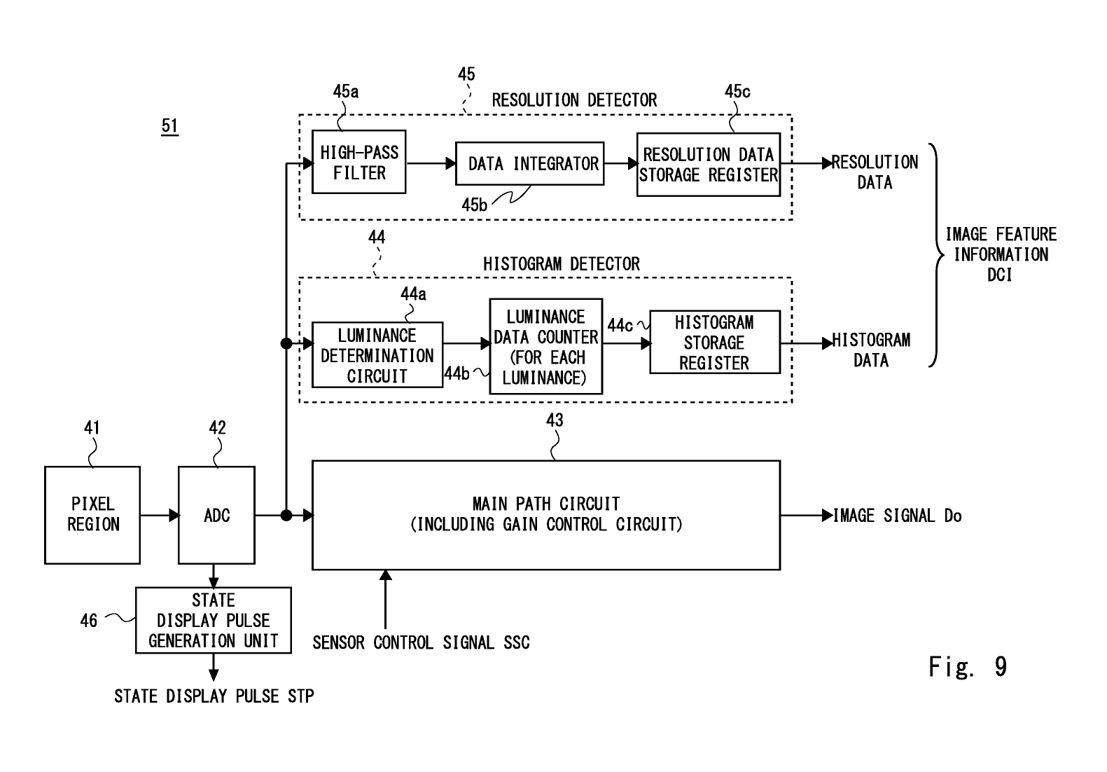

The sensor 51 outputs the state display pulse STP. The state display pulse STP indicates a period where the analog-to-digital converter 42 in the sensor 51 performs analog-to-digital conversion that converts the photoreceptor pixel information generated according to the amount of received light into a digital value. For example, the state display pulse STP at Low level indicates a period where the analog-to-digital conversion is performed, and the state display pulse STP at High level indicates a period where the analog-to-digital conversion is not performed. FIG. 9 shows a block diagram of the image sensor 9.

As shown in FIG. 9, the sensor 51 according to the second embodiment further includes a state display pulse generation unit 46 in addition to the elements of the sensor 15. The state display pulse generation unit 46 monitors the operation of the analog-to-digital converter 42 and generates a state display pulse indicating that the analog-to-digital converter 42 is in the period of conversion. Note that, an operation clock (not shown) indicating the conversion period is input to the analog-to-digital converter 42, and the state display pulse generation unit 46 monitors this operation clock and generates the state display pulse STP. Note that the state display pulse STP may be output from the analog-to-digital converter 42 or output from a timing control circuit (not shown) that controls the timing of the analog-to-digital converter 42.

The module control MCU 52 stops controlling the lens group during the period indicated by the state display pulse STP as the period to perform the analog-to-digital conversion. The operation of the lens module 50 according to the second embodiment, including the operation of the module control MCU 52, is described in detail hereinbelow.

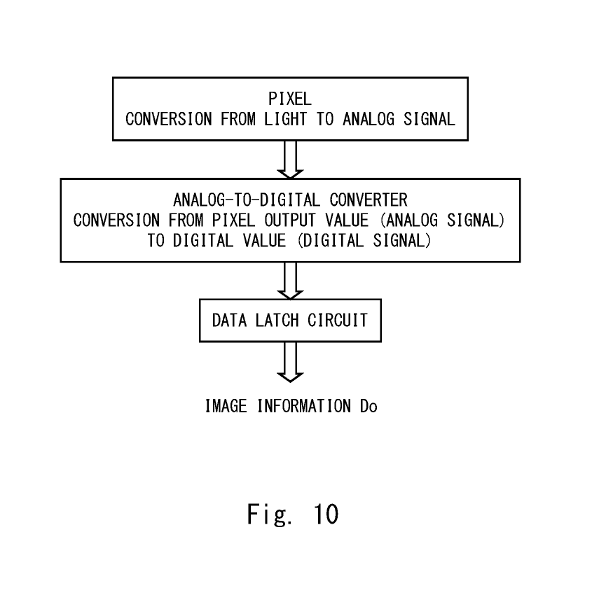

First, a process flow until the lens module 50 according to the second embodiment outputs the image information Do is described. FIG. 10 shows a view illustrating a signal flow until the image information is output from incident light in the lens module 50 according to the second embodiment. As shown in FIG. 10, in the lens module 50, incident light is first converted into an analog signal having a signal level corresponding to the amount of incident light in the pixel region of the sensor 51. Next, in the lens module 50, the analog-to-digital converter 42 converts the analog signal into a digital signal indicating the signal level of the analog signal. Then, in the lens module 50, the digital signal output from the analog-to-digital converter 42 is stored in a data latch circuit in the main path circuit 43. After that, the lens module 50 outputs the image information Do that is stored in the data latch circuit.

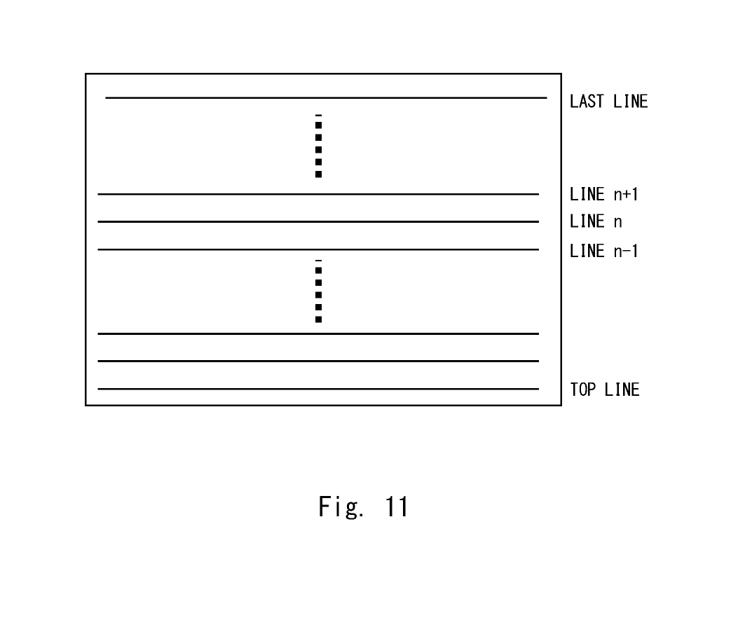

A method of reading pixels in the lens module 50 is described hereinafter. In the lens module 50, pixels are arranged in a lattice in a pixel region of the sensor 51. In the lens module 50, information of the pixels arranged in a lattice is read on row-by-row basis. FIG. 11 is a view illustrating lines that are set in an imaging region in the image sensor according to the second embodiment. As shown in FIG. 11, in the lens module 50, a line is set for each row, and pixel information is read on a line-by-line basis. Then, in the lens module 50, one image information is generated by reading the pixel information from all lines from the first line to the last line.

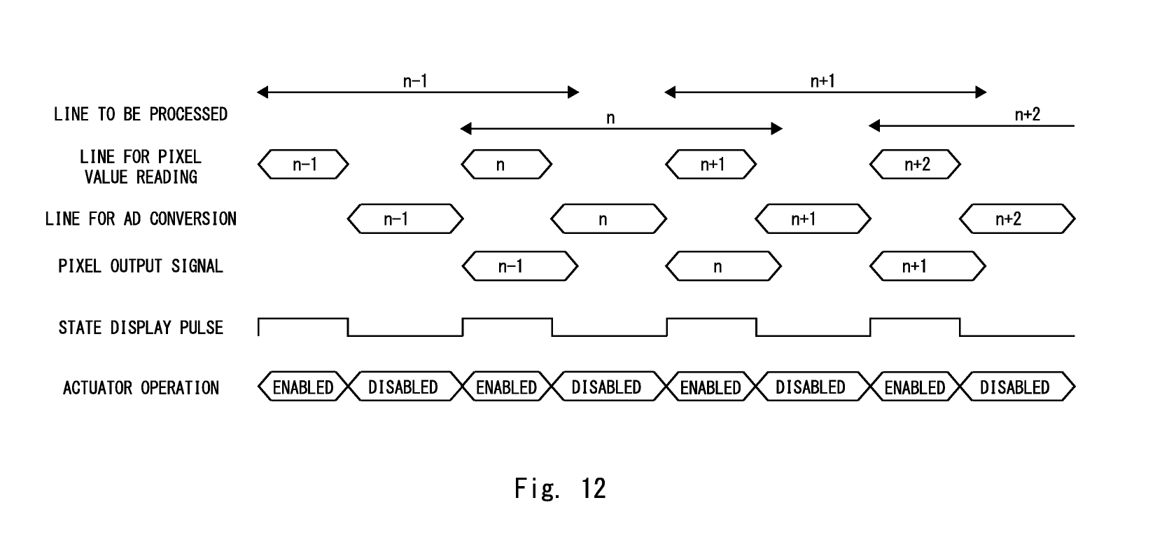

FIG. 12 shows a timing chart illustrating the operation of the lens module 50. FIG. 12 shows an example that reads information of pixels sequentially from the (n−1)th line. As shown in FIG. 12, in the lens module 50, pixel value reading, analog-to-digital conversion, and output of a pixel output signal (for example, a digital signal output from the analog-to-digital converter 42) are sequentially performed for one line. Further, in the lens module 50, there is a period where the reading of pixel values in the current line and the output of digital values of pixels in the previous line are performed in parallel.

Then, the sensor 51 outputs the state display pulse STP that becomes Low level in the period where the analog-to-digital conversion is performed. Then, the module control MCU 52 that receives the state display pulse STP disables the operation of the zoom actuator 16 and the focus actuator 17 during the period where the state display pulse STP is Low level. Further, the module control MCU 52 enables the operation of the zoom actuator 16 and the focus actuator 17 during the period where the state display pulse STP is High level.

As described above, the lens module 50 according to the second embodiment stops the operation of the actuators during the period where the analog-to-digital converter 42 performs analog-to-digital conversion in the sensor 51. When the actuators operate, the current consumption increases, and the power supply noise of the sensor 51 can increase accordingly. Further, the accuracy of analog-to-digital conversion can be degraded due to the effect of the power supply noise. In the lens module 50 according to the second embodiment, it is possible to reduce the power supply noise and prevent the degradation of the accuracy of analog-to-digital conversion by stopping the operation of the actuators during the analog-to-digital conversion.

Further, in the lens module 50 according to the second embodiment, the processing of disabling the operation of the actuators during the analog-to-digital conversion in the sensor 51 is carried out in the lens module. Therefore, a designer who uses the lens module 50 can obtain the image information Do with high image quality without consideration of the effects of the actuator operation on the quality of the image information Do.

### Third Embodiment

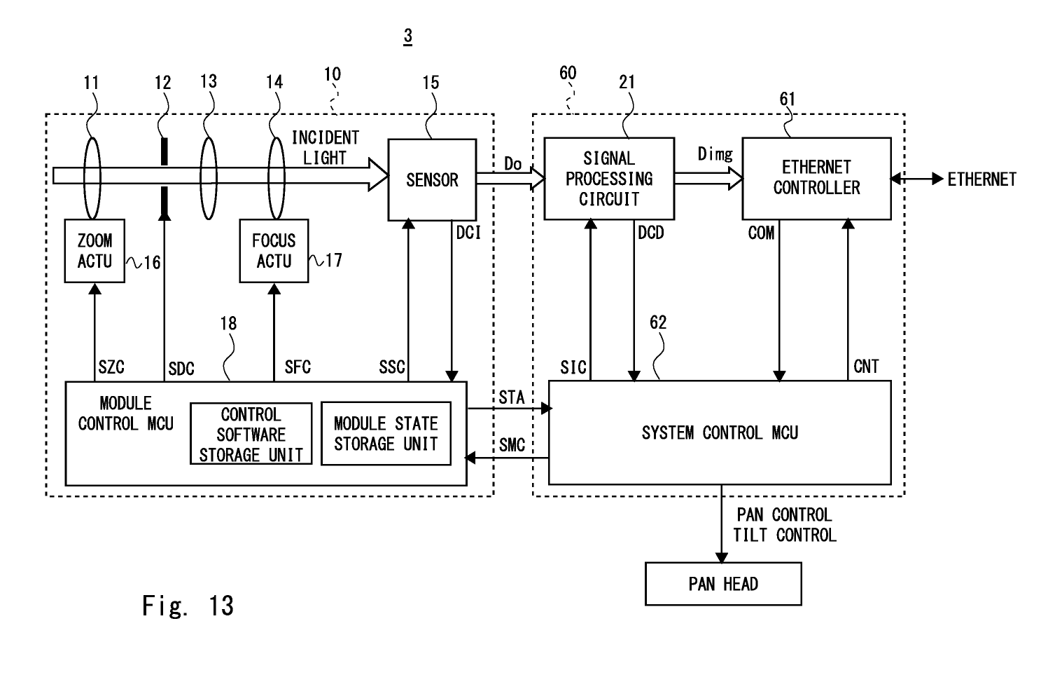

In a third embodiment, a camera body 60, which is an alternative example of the camera body 20, is described. FIG. 13 shows a block diagram of a camera system 3 including the camera body 60. Note that, in the description of the third embodiment, the elements described in the first embodiment are denoted by the same reference symbols as in the first embodiment and not redundantly described below.

As shown in FIG. 3, the camera body 60 further includes an Ethernet controller 61 (Ethernet is a registered trademark) in addition to the elements of the camera body 20. Further, the camera body 60 includes a system control MCU 62 in place of the system control MCU 22. The system control MCU 62 further has a function of transmitting and receiving signals with the Ethernet controller and a function of controlling a pan head that is placed outside in addition to the functions of the system control MCU 22.

The Ethernet controller 61 is an interface circuit for connecting the camera body 60 to the Ethernet. The camera body 60 outputs the image data Dimg through the Ethernet to a storage unit or the like that is placed outside. Further, the Ethernet controller 61 receives a control instruction or the like through the Ethernet from an external device and outputs the received control instruction COM to the system control MCU 62. Further, the system control MCU 62 outputs an Ethernet control signal CNT for controlling the transmitting and receiving state of the Ethernet to the Ethernet controller 61.

The operation of the camera system 3 according to the third embodiment is described hereinafter. In the following description, a system control MCU that performs control of the lens group and control of the sensor 15 without using the module control MCU 18 is described as a comparative example. Further, the operation of the system control MCU is mainly described in the following description.

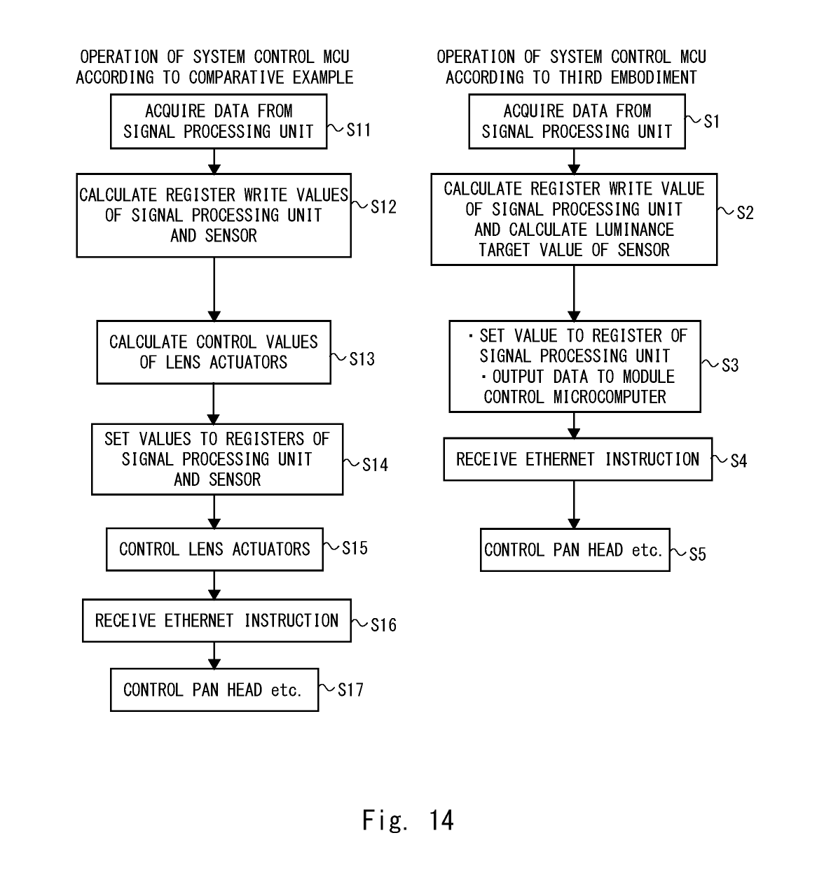

FIG. 14 shows a flowchart comparing the operation of the camera system according to the third embodiment with the operation of a camera system according to a comparative example. As shown in FIG. 14, the system control MCU according to the comparative example repeatedly performs the processing in Steps S11 to S17, and the system control MCU 62 according to the third embodiment repeatedly performs the processing in Steps S1 to S5.

First, the system control MCU according to the comparative example acquires the color space information DCD from the signal processing circuit 21 (Step S11). Next, the system control MCU according to the comparative example calculates control values to be written to the registers of the signal processing circuit 21 and the sensor 15 based on the acquired color space information DCD (Step S12). Then, the system control MCU according to the comparative example calculates control values of the respective lens actuators based on the color space information DCD (Step S13).

Then, the system control MCU according to the comparative example writes the control values calculated in Step S12 into the register of the signal processing circuit 21 and the sensor 15 (Step S14). Then, the system control MCU according to the comparative example controls the respective lens actuators based on the control values calculated in Step S13 (Step S15).

After that, the system control MCU according to the comparative example receives a control instruction COM from the Ethernet (Step S16). Then, the system control MCU according to the comparative example controls the pan head based on the control instruction COM or the like that is supplied through the Ethernet (Step S17).

Now, the operation of the system control MCU 62 according to the third embodiment is described hereinafter with reference to FIG. 14. The system control MCU 62 according to the third embodiment first acquires the color space information DCD from the signal processing circuit 21 (Step S1). Next, the system control MCU 62 according to the third embodiment calculates a control value to be written to the register of the signal processing circuit 21 based on the acquired color space information DCD and also calculates a luminance target value of the sensor (Step S2). Then, the system control MCU 62 according to the third embodiment writes the control value calculated in Step S2 into the register of the signal processing circuit 21 and outputs the luminance target value of the sensor 15 as a luminance change instruction to the module control MCU 18 (Step S3). Then, the system control MCU 62 according to the third embodiment receives the control instruction COM from the Ethernet (Step S4). After that, the system control MCU 62 according to the third embodiment controls the pan head based on the control instruction COM or the like that is supplied through the Ethernet (Step S5).

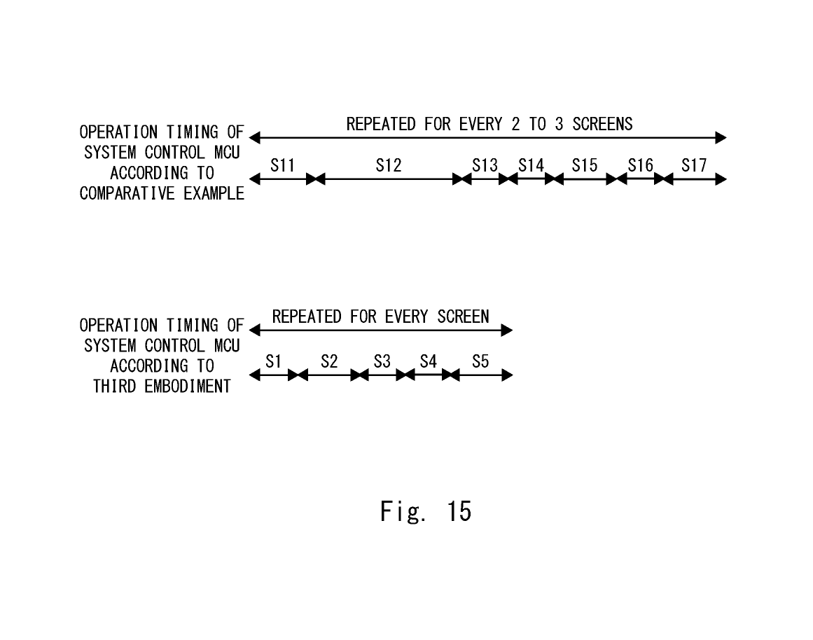

The timing when each processing shown in FIG. 14 is performed is described hereinbelow. FIG. 15 shows a timing chart comparing the operation of the camera system according to the third embodiment with the operation of the camera system according to the comparative example. In FIG. 15, the same reference symbols as those of Steps shown in FIG. 14 are used as the reference symbols of the respective processing.

As shown in FIG. 15, in the system control MCU according to the comparative example, the calculation of control values in Step S12 is particularly longer than the calculation of a control value in Step S2 in the system control MCU 62 according to the third embodiment. This is because the number of control values to be calculated is larger in the system control MCU according to the comparative example. Further, as shown in FIG. 15, the number of processing to be performed in the system control MCU 62 according to the third embodiment is smaller by two than the number of processing to be performed in the system control MCU according to the comparative example.

There are above-described differences in the number of processing and the time of processing between the system control MCU according to the comparative example and the system control MCU 62 according to the third embodiment. Due to those differences, the system control MCU according to the comparative example requires a period to process the image information Do for two to three screens as the period to perform the processing in Steps S11 to S17. On the other hand, the system control MCU according to the comparative example can perform the processing in Steps S1 to S5 in a period to process the image information Do for one screen.

As described above, the system control MCU according to the comparative example requires the calculation of controls values related to the actuators and the sensor 15 and further requires a large number of processing, and it thus takes a long time to perform a series of processing steps. On the other hand, in the system control MCU 62 according to the third embodiment, because the calculation of controls values related to the actuators and the sensor 15 is performed in the lens module 10, it possible to reduce the calculation of control values and the number of processing, and it is thus possible to perform a series of processing steps in a short cycle.

Therefore, in the camera system 3 according to the third embodiment, it is possible to make precise control of the actuators and the sensor 15. Further, because the amount of processing to be performed in the camera system 3 according to the third embodiment is small, it is possible to use a processor with a low processing power as the system control MCU 62.

### Fourth Embodiment

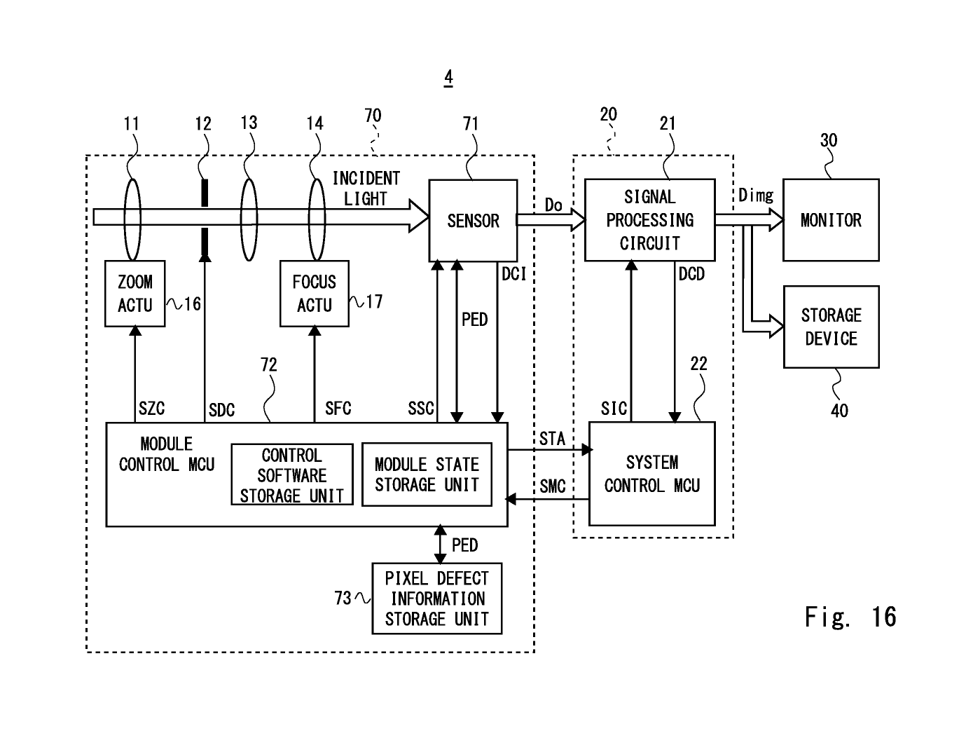

In a fourth embodiment, a lens module 70, which is an alternative example of the lens module 10, is described. FIG. 16 is a block diagram of a camera system 4 including the lens module 70 according to the fourth embodiment. Note that, in the description of the fourth embodiment, the elements described in the first embodiment are denoted by the same reference symbols as in the first embodiment and not redundantly described below.

The lens module 70 according to the fourth embodiment includes a sensor 71 and a module control MCU 72 in place of the sensor 15 and the module control MCU 18 of the sensor module 10, respectively. Further, the lens module 70 further includes a pixel defect information storage unit 73 in addition to the elements of the lens module 10.

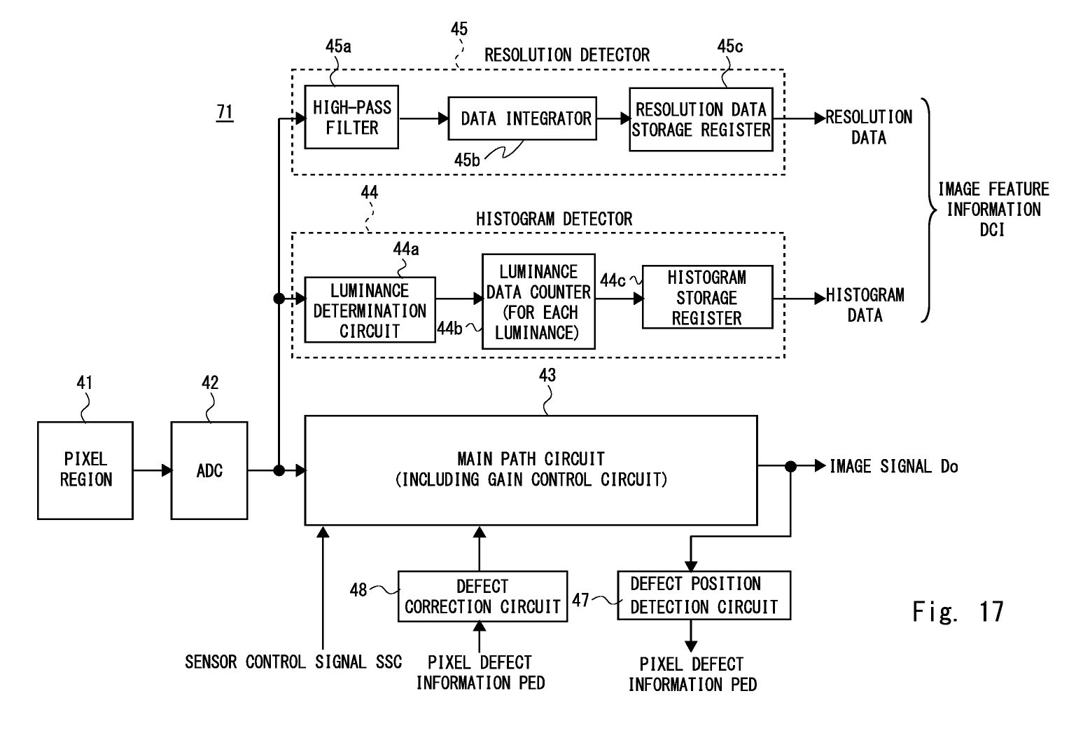

The sensor 71 further includes a function of generating pixel defect information PED and a function of correcting a pixel defect based on the pixel defect information PED in addition to the functions of the sensor 15. FIG. 17 shows a block diagram of the sensor 71. As shown in FIG. 17, the sensor 71 includes a defect position detection circuit 47 and a defect correction circuit 48 in addition to the elements of the sensor 15.

The defect position detection circuit 47 analyzes the image information Do to detect a pixel defect, and when a pixel defect is found, outputs information indicating the position of the pixel defect as the pixel defect information PED. The defect position detection circuit 47 generates the pixel defect information PED in shipping inspection of the lens module 10. The generated pixel defect information PED is stored into the pixel defect information storage unit 73.

The defect correction circuit 48 reads the pixel defect information PED from the pixel defect information storage unit 73 at the startup and corrects the pixel defect based on the pixel defect information PED. Then, the sensor 71 outputs the image information Do after making pixel correction through the main path circuit 43. This pixel defect correction is performed continuously during the period when the sensor 71 is operating. Further, the pixel defect correction can be done by replacing a pixel defect with the average of information of surrounding pixels, for example.

The module control MCU 72 further includes a function related to transmitting and receiving of the pixel defect information PED in addition to the functions of the module control MCU 18. The pixel defect information storage unit 73 is a nonvolatile memory that stores the pixel defect information PED.

The operation of the camera system 4 according to the fourth embodiment is described hereinafter. The camera system 4 according to the fourth embodiment is different from the camera system 1 according to the first embodiment only in the storage of the pixel defect information PED and the pixel defect correction based on the pixel defect information PED. Thus, processing related to acquiring and storing the pixel defect information and processing of reading the pixel defect information PED in the camera system 4 according to the fourth embodiment are described in detail below.

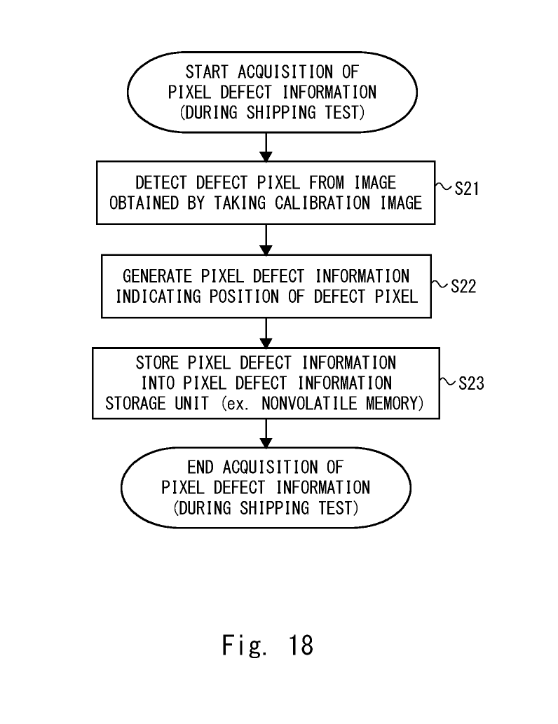

FIG. 18 shows a flowchart of a method for acquiring pixel defect information in the lens module 70 according to the fourth embodiment. As shown in FIG. 18, in the lens module 70 according to the fourth embodiment, the pixel defect information PED is acquired during shipping test. The lens module 70 first takes an image for calibration by the lens module 70. Then, the lens module 70 detects a pixel defect from the image taken (Step S21). Then, the defect position detection circuit 47 generates the pixel defect information PED indicating the position of the pixel defect (Step S22). Then, in the lens module 70, the pixel defect information PED is stored into the pixel defect information storage unit 73 (Step S23). Note that the pixel defect information PED may be generated using a defect position detection function incorporated in a test device for shipping inspection of the lens module 70 and stored into the pixel defect information storage unit 73. In this case, the defect position detection circuit 47 can be deleted from the sensor 71.

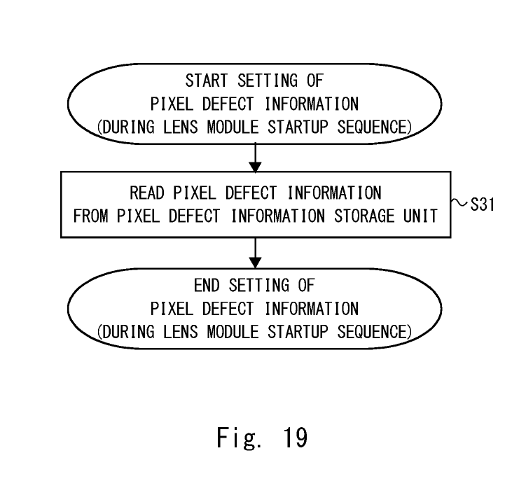

FIG. 19 shows a flowchart for reflecting the pixel defect information on the system in the lens module according to the fourth embodiment. As shown in FIG. 19, in the lens module 70, reading of the pixel defect information PED is done as one processing of a startup sequence of the lens module 70 (Step S31). In the lens module 70, the pixel defect correction is started upon reading of the pixel defect information PED by the defect correction circuit 48 of the sensor 71.

As described above, in the camera system 4 according to the fourth embodiment, the pixel defect information PED indicating the position of a pixel defect is stored in the lens module 70, and the pixel defect correction is done based on the pixel defect information PED. A camera manufacturer that uses the lens module 70 according to the fourth embodiment can thereby obtain the suitable image information Do with no pixel defect without the need to create a program or the like related to the correction of a pixel defect occurring in the sensor 71.

While the invention has been described in terms of several embodiments, those skilled in the art will recognize that the invention can be practiced with various modifications within the spirit and scope of the appended claims and the invention is not limited to the examples described above.

The first to fourth embodiments can be combined as desirable by one of ordinary skill in the art.

Further, the scope of the claims is not limited by the embodiments described above.

Furthermore, it is noted that, Applicant's intent is to encompass equivalents of all claim elements, even if amended later during prosecution.

What is claimed is:

1. A lens module system comprising:
a lens group with variable focus;
an image sensor that receives light entering through the lens group and outputs image information, and outputs image feature information representing a feature of the image information; and
a module control unit that controls at least one of focus of the lens group and exposure setting of the image sensor based on the image feature information output from the image sensor.

2. The lens module system according to claim 1, wherein the module control unit changes a magnification of the lens group based on a zoom setting value specifying a zoom magnification from a system control unit that is provided separately from the module control unit and controls a whole camera system based on an instruction from a user, and controls focus at the changed magnification.

3. The lens module system according to claim 2, wherein the module control unit controls exposure of the image information based on an exposure control value supplied from the system control unit.

4. The lens module system according to claim 3, wherein
the image feature information contains histogram data of the image information, and
the module control unit controls exposure setting and gain setting of the image sensor based on the histogram data so that the histogram data of the image information matches the exposure control value.

5. The lens module system according to claim 1, wherein
the image feature information contains resolution information indicating sharpness of an edge of the image information, and
the module control unit searches for a lens position where the resolution information reaches maximum by moving a lens included in the lens group, and sets the lens position where the resolution information reaches maximum as a position where focus is achieved.

6. The lens module system according to claim 2, wherein the module control unit initializes the lens module system based on a power-on reset instruction supplied from the system control unit, and terminates the lens module system based on a power-off instruction supplied from the system control unit.

7. The lens module system according to claim 1, wherein
the image sensor outputs a state display pulse indicating a period to perform analog-to-digital conversion that converts photoreceptor pixel information generated according to an amount of received light into a digital value, and
the module control unit stops controlling the lens group during a period where the state display pulse indicates the period to perform analog-to-digital conversion.

8. The lens module system according to claim 2, wherein the module control unit calculates a control value of a lens actuator that controls a component included in the lens group based on an instruction from the system control unit.

9. The lens module system according to claim 1, further comprising:
a pixel defect information storage unit that stores pixel defect information of the image sensor, wherein
the image sensor reads the pixel defect information from the pixel defect information storage unit at startup, and outputs the pixel information after making pixel correction based on the pixel defect information.

10. The lens module system according to claim 9, wherein the pixel defect information is stored into the pixel defect information storage unit at shipment of the lens module system.

11. An image sensor comprising:
a sensor unit that outputs photoreceptor pixel information generated according to an amount of light entering through a lens group with variable focus;
an analog-to-digital converter that converts the photoreceptor pixel information into a digital value and generates image information;
an image analysis unit that analyzes the image information output from the analog-to-digital converter and outputs image feature information representing a feature of the image information; and
a main path circuit that outputs the pixel information to outside.

12. The image sensor according to claim 11, wherein the image analysis unit includes:
a resolution information generation unit that generates resolution information indicating sharpness of an edge of the image information.

13. The image sensor according to claim 12, wherein the resolution information generation unit includes:
a high-pass filter that extracts pixels of a part serving as an edge in the image information;
a data integrator that integrates the number of pixels extracted by the high-pass filter; and
a resolution data storage register that stores the number of pixels integrated by the data integrator.

14. The image sensor according to claim 11, wherein the image analysis unit includes:
a histogram generation unit that generates histogram data of the image information.

15. The image sensor according to claim 14, wherein the histogram generation unit includes:
a luminance determination circuit that determines a luminance of each of pixels contained in the image information;
a luminance data counter that counts pixels whose luminance is determined by the luminance determination circuit on a luminance-by-luminance basis and generates histogram data; and
a histogram storage register that stores the histogram data.

16. The image sensor according to claim 11, wherein the main path circuit performs gain control that changes a luminance resolution for each pixel according to a luminance of pixels in the image information based on an instruction from outside.

17. The image sensor according to claim 11, comprising:
a state display pulse generation unit that generates a state display pulse indicating that the analog-to-digital converter is in a period of conversion.

18. The image sensor according to claim 11, comprising:
a pixel defect correction circuit that reads pixel defect information at startup from a pixel defect information storage unit placed outside, and performs pixel defect correction that corrects a pixel defect contained in the image information based on the pixel defect information.

19. A method of controlling a lens module including a lens group with variable focus and an image sensor that receives light entering through the lens group and outputs image information, the method comprising:
calculating a control value for determining a state of a component included in the lens group based on an instruction from a system control unit provided separately from the lens module;
acquiring image feature information representing a feature of the image information from the image sensor; and
controlling the component included in the lens group so that at least one of focus of the image information and exposure setting of the image sensor becomes an appropriate value based on the calculated control value and the acquired image feature information.
